(19) United States
(12) Patent Application Publication
(10) Pub. No.: US 2011/0098963 A1
(43) Pub. Date: Apr. 28, 2011

(54) CONTEXT BASED TESTING

(75) Inventor: Lakshmankumar Mukkavilli, Sunnyvale, CA (US)

(73) Assignee: Cisco Technology, Inc., San Jose, CA (US)

(21) Appl. No.: 12/605,130

(22) Filed: Oct. 23, 2009

(51) Int. Cl. G06F 19/00

(52) U.S. Cl. 702/123

(57) ABSTRACT

In an embodiment, a method is provided. In this method, contexts used in a test are accessed, and these contexts are defined separate from the test. One of these contexts (a “first context”) defines a dependency to another context (a “second” context). A system of relationships between the contexts is constructed based on the dependency defined by the first context. The test is then executed using a number of contexts identified from the system of relationships.

### FIELD

The present disclosure relates generally to testing of hardware and software.

### BACKGROUND

Tests may be executed on a variety of hardware and/or software to verify that they work as expected concerning, for example, functional correctness and performance. To test a particular software or hardware component, a programmer generates a set of instructions that tests such a component. This set of instructions typically includes commands, configurations, and parameters. In many tests, a single type of test is repeated with different configurations and parameters. As a result, even though the type of test is the same, a programmer needs to generate a customized set of instructions for each different configuration and execute each customized set of instructions individually. The execution of these tests may therefore be inefficient given that each test can take a long time to execute and most of these tests are just slight variations of each other.

### BRIEF DESCRIPTION OF DRAWINGS

The present disclosure is illustrated by way of example and not limitation in the figures of the accompanying drawings, in which like references indicate similar elements and in which:

FIG. 1 depicts a graph diagram, consistent with an embodiment of the present invention, illustrating a system of relationships between contexts;

FIG. 2 depicts a diagram of syntax used for defining contexts, consistent with various embodiments of the invention;

FIG. 3 depicts a block diagram of various modules, in accordance with an embodiment, included in an apparatus that is configured to test software and/or hardware;

FIG. 4 depicts a flow diagram of a general overview of a method, in accordance with an embodiment, for executing tests;

FIG. 5 depicts a graph representation of a system of relationships between contexts, according to one embodiment of the present invention;

FIG. 6 defines an example of a template that may be used to define each node, in accordance with an embodiment of the present invention;

FIG. 7 depicts a graph representation of the system of relationships illustrating executions of tests in a sequence using a number of contexts identified from the system;

FIG. 8 depicts a graph representation of the system of relationships illustrating executions along a different path, in accordance with another embodiment of the present invention;

FIG. 9 is a table that lists some execution sequences for the example of the system of relationships illustrated in FIGS. 5, 7, and 8; and

FIG. 10 depicts a block diagram of a machine in the example form of an apparatus within which may be executed a set of instructions for causing the machine to perform any one or more of the methodologies discussed herein.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

Overview

A method is provided for context-based testing. In this method, contexts used in a test are accessed, and these contexts are defined separate from the test. One of these contexts (a “first context”) defines a dependency to another context (a “second” context). A system of relationships between the contexts is constructed based on the dependency defined by the first context. The test is then executed using a number of contexts identified from the system of relationships.

### Example Embodiments

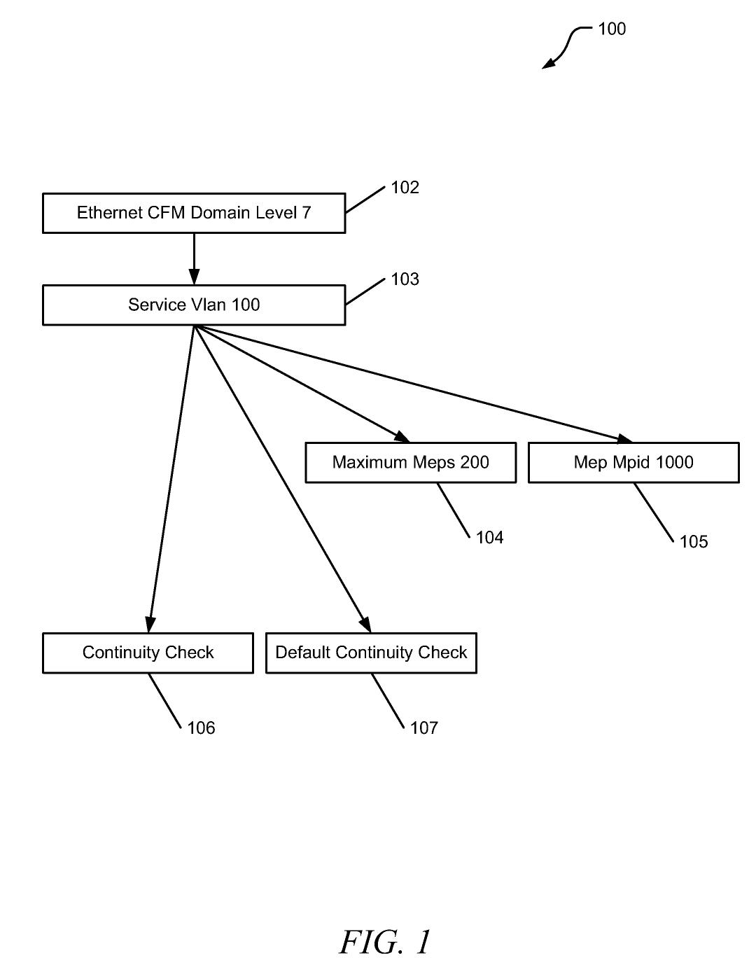

FIG. 1 depicts a graph diagram, consistent with an embodiment of the present invention, illustrating a system 100 of relationships between contexts. As illustrated, the system 100 of relationships includes nodes 102-107, each of which is associated with a particular context 102-107. The lines represent the relationships between the nodes 102-107. A “context,” as used herein, defines, for example, conditions, configurations, parameters, and/or other information under which one or more tests are executed. As an example, a context may define activities performed prior to and during the execution of a test. In this example, an ability of a device to communicate with another device is tested, and the context here can define configurations that are used on both devices. It should be appreciated that operating systems have a set of configuration commands that support different features, and a context, in another example, may include such configuration commands. In testing a file system of an operating system, examples of contexts may include mode (e.g., R/W/U), media type (e.g., main memory, flash memory, and hard disk), variable type (e.g., text and binary), and other configuration or parameters associated with the file system. Contexts can also include environment variables, which may be added by a “setenv( )” function or may be removed by an “unsetenv( )” function. As explained in more detail below, the contexts 102-107 may additionally include instructions used in validations and/or instructions that undo particular configurations.

In the example of FIG. 1, each node 102, 103, 104, 105, 106, or 107 is associated with a different context, each of which defines a different configuration and/or parameter. As depicted, node 102 is associated with a context that defines a configuration of the “Ethernet Connectivity Fault Management (CFM) domain” to be level 7. In another example, node 104 is associated with a context that defines a maximum number of main entry points (MEPS) to be 200. Node 106 is associated with a context that defines a use of a particular continuity check while node 107 is associated with a context that defines the use of a default continuity check.

Embodiments of the invention provide that tests be executed using a number of contexts identified from the system 100 of relationships. In an embodiment, multiple tests may be executed in series following a path along the system 100 of relationships. In a path that traverses nodes 102, 103, and 104, a test can be initially executed using a context associated with node 102 where the test is executed with the Ethernet CFM domain set to level 7. Thereafter, another test can be executed using contexts associated with nodes 102 and 103 where the same test is executed, but in addition to setting the Ethernet CFM domain to level 7, the service virtual local area network (VLAN) is set to 100. A third test may then be executed where the Ethernet CFM domain is set to level 7, the service VLAN is set to 100, and the maximum number of MEPS is set to 200.

In another example where the path traverses nodes 102, 103, and 107, a test can be initially executed using a context associated with node 102 where the test is executed with the Ethernet CFM domain set to level 7. Thereafter, another test can be executed using contexts associated with nodes 102 and 103 where the same test is executed, but in addition to setting the Ethernet CFM domain to level 7 service VLAN is set to 100. A third test may then be executed where the Ethernet CFM domain is set to level 7, the service VLAN is set to 100, and with the use of a default continuity check.

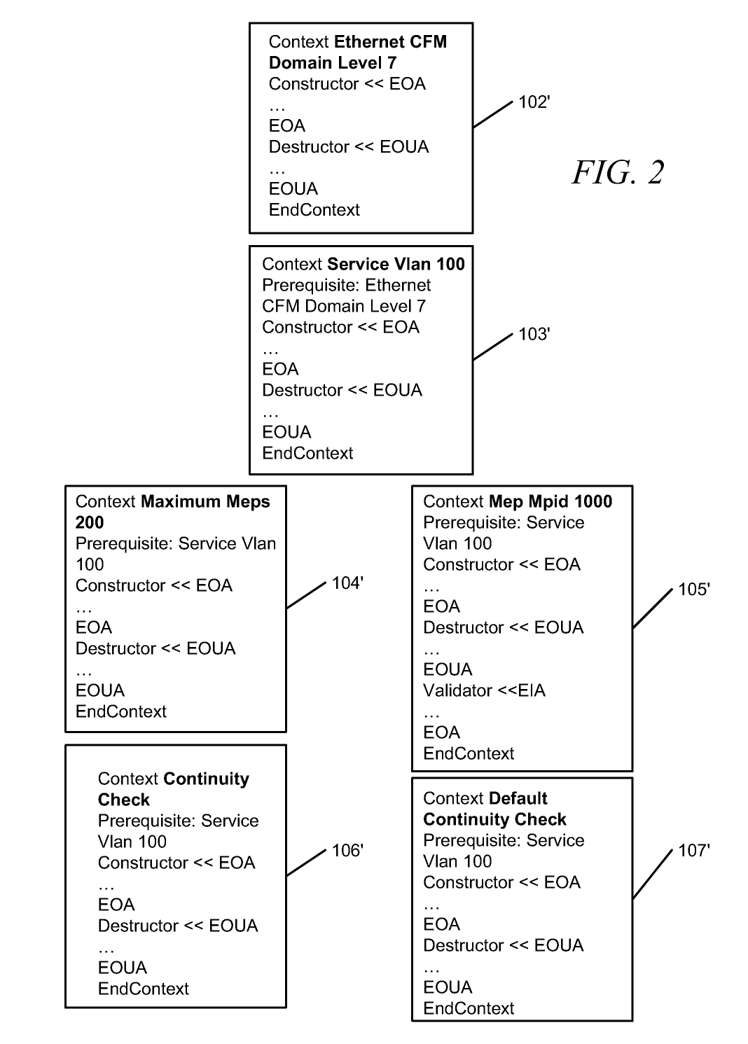

FIG. 2 depicts a diagram of syntax used for defining contexts 102′-107′, consistent with various embodiments of the invention. The contexts 102′-107′ are defined separately from the test. A test can be a set of instructions written in, for example, a scripting language (e.g., Tool Command Language (TCL)) or a programming language (C language), that test hardware and/or software. Rather than defining the contexts 102′-107′ within the test's set of instructions, the contexts 102′-107′ are separately defined. For example, the test may be a set of instructions and the contexts are excluded from the set of instructions. In an embodiment, if the contexts 102′-107′ are stored in the same file with the test, then the contexts 102′-107′ may be grouped separately from the test. In another embodiment, the contexts 102′-107′ may be stored in one or more files separate from another file that stores the test's set of instructions. By separating the test from the contexts 102′-107′, the contexts 102′-107′ may, for example, be reused for other tests. In addition, the separation also reduces the number of instructions generated for testing and provides a broader coverage for the execution of the tests, as described in more detail below.

The contexts as a whole may be divided or grouped into multiple contexts 102′-107′ with each context 102′, 103′, 104′, 105′, 106′, or 107′ defined by separate syntax. As depicted, the syntax may include a name of a context 102′, 103′, 104′, 105′, 106′, or 107′, one or more dependencies (or prerequisites), a constructor, a deconstructor, and a validator. A “constructor,” as used herein, refers to a mechanism or a set of instructions that implements or creates the context. For example, the constructor may define conditions, configurations, and/or parameters. On the other hand, a “deconstructor,” as used herein, refers to a mechanism or a set of instructions that undoes the effects of the constructor. That is, the destructor reverses the effect of the constructor. As an example, the constructor may define a particular configuration and the destructor may include instructions to undo the configuration. Here, the constructor can be a particular configuration command (e.g., “banner exec”) and the deconstructor could be another configuration command with a “no” prefix (e.g., “no banner exec”).

Additionally, a number of contexts, such as context 103′-107′, may define a dependency to another context. A dependency identifies a context required by another context. For example, as depicted in FIG. 2, the context 103′ defines a dependency (or prerequisite) to a context “Ethernet CFM Domain Level 7,” which refers to context 102′. As a result, a test cannot be executed using context 103′ alone, but requires both contexts 102′ and 103′. In another example, the context 104′ defines a dependency to “Service VLAN 100,” which refers to context 103′. In turn, context 103′ further defines a dependency to context 102′. As a result, a test cannot be executed using context 104′ alone, but requires contexts 102′, 103′, and 104′. It should be appreciated that multiple dependencies may be defined. For example, the context 107′ may define an additional dependency to context 104′ (“Maximum MEPS 200”) in addition to context 103′ (“Service VLAN 100”).

In some embodiments, a number of the contexts, such as context 105, may further include a validator. A “validator,” as used herein, refers to a mechanism or set of instructions that checks and/or verifies an expected outcome of a constructor. As an example, a validator may include a set of instructions that validate an outcome of a configuration. In another example, the validator can be a sequence of assertions or results associated with a constructor, which is included within a particular context.

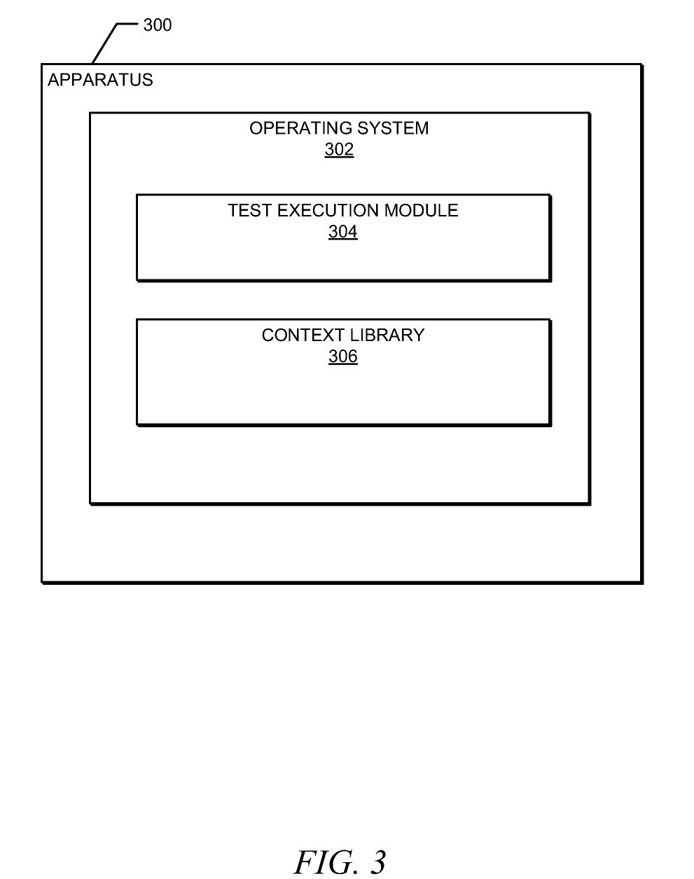

FIG. 3 depicts a block diagram of various modules, in accordance with an embodiment, included in an apparatus 300 that is configured to test software and/or hardware. It should be appreciated that the apparatus 300 may be deployed in the form of a variety of computing devices, such as personal computers, laptops computers, server computers, personal digital assistants, or other computing devices. In various embodiments, the apparatus 300 may be used to implement computer programs, logic, applications, methods, processes, or other software to test software or hardware based on separate contexts, as described in more detail below.

The apparatus 300 executes an operating system 302 (e.g., Internetwork Operating System) that manages the software processes and/or services executing on the apparatus 300. As depicted in FIG. 3, these software processes and/or services may include a test execution module 304 and a context library 306. The context library 306 is configured to store contexts and may be a data structure that includes, for example, tables, arrays, linked lists, databases, and other data structures. The contexts may be stored as a single file or each context may be stored in separate files within the context library 306.

The test execution module 304 is configured to execute tests using contexts accessed from the context library 306. The test execution module 304 may access contexts used in a test from the context library 306 and construct a system of relationships between the contexts, as explained in more detail below. After the system of relationships is constructed, a series of tests is executed in sequence using a number of contexts identified from the system of relationships.

It should be appreciated that in other embodiments, the apparatus 300 may include fewer, more, or different modules apart from those shown in FIG. 3. For example in an embodiment, the test execution module 304 may also be configured to store contexts and therefore, in this embodiment, the apparatus 300 may not include the context library 306.

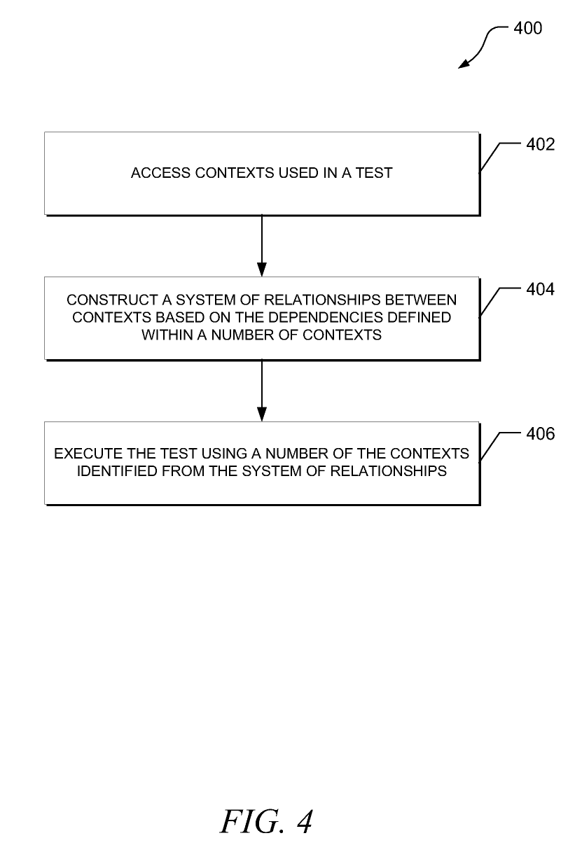

FIG. 4 depicts a flow diagram of a general overview of a method 400, in accordance with an embodiment, for executing tests. In one embodiment, the method 400 may be implemented by the test execution module 304 and employed in the apparatus 300 of FIG. 3. As depicted at 400 of FIG. 4, all the contexts used in a test are accessed at 402. As discussed above, the contexts are defined separate from the test and a number of these contexts define dependencies to each other.

A system of relationships between the contexts is then constructed at 404 based on the defined dependencies. In constructing the system of contexts, the dependencies are first identified from the contexts. Thereafter, the contexts are related to each other based on the dependencies. The system of relationships may be constructed in a number of different techniques. In one embodiment, for example, the system of relationships may be constructed as a directed acyclic graph, which is described in more detail below.

After the system of relationships is constructed, a series of tests may be executed at 406 using the contexts identified from the system of relationships. As a result, for example, a series of tests can be executed in series using a variety of different combinations of contexts as identified from the system of relationships.

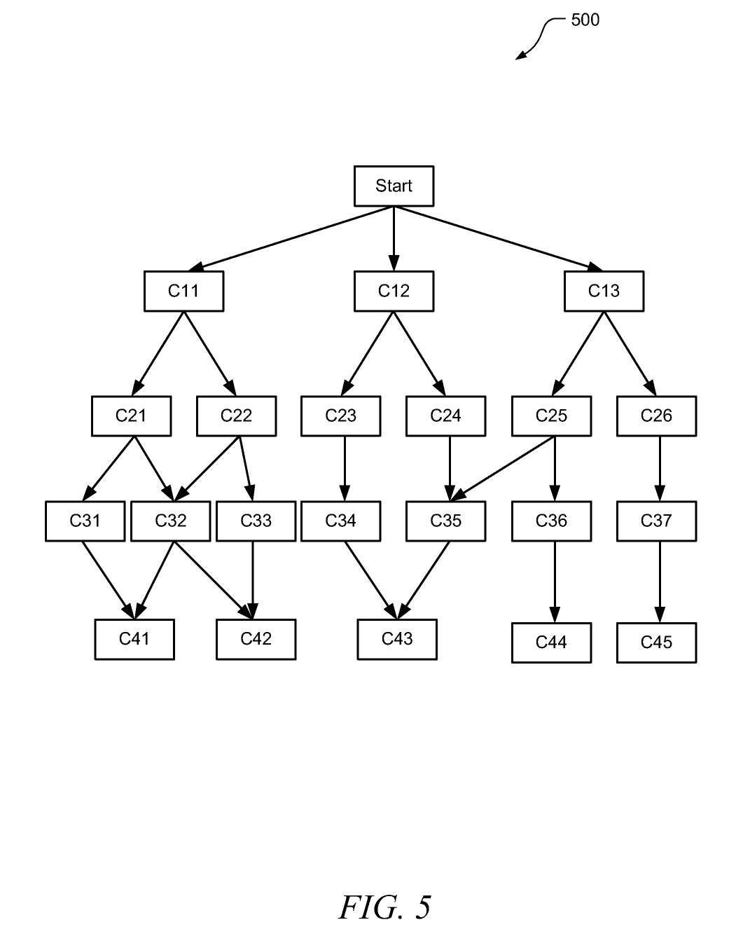

FIG. 5 depicts a graph representation of a system 500 of relationships between contexts, according to one embodiment of the present invention. In this example, the system 500 is constructed as a directed acyclic graph that comprises multiple nodes C11-C45. A directed acyclic graph refers to a directed graph without directed cycles. That is, a directed acyclic graph does not have loops. Each node is associated with a single context and the lines between the nodes C11-C45 illustrate the relationships between the contexts.

To construct the system 500 of relationships, for example, all the contexts associated with one or more tests are initially accessed from a context library. The dependencies defined the contexts are identified and the contexts are related to each other based on the dependencies. In FIG. 5, the context associated with node C21 defines context associated with node C11 as a dependency. As a result, the directed acyclic graph shows a line connecting node C11 to node C21. Additionally, the context associated with node C31 defines the context associated with node C21 as a dependency and therefore, the directed acyclic graph shows a line connecting node C21 to node C31. Furthermore, the context associated with node C41 defines contexts associated with nodes C31 and C32 as alternate dependencies, and the directed acyclic graph thereby shows lines from nodes C31 and C32 to node C41. The contexts associated with nodes C21 and C22 only define dependencies to context associated with node C11. As a result, there is no direct relationship between contexts associated with nodes C21 and C22. Therefore, the directed acyclic graph does not show a line connecting node C21 to node C22.

As depicted in the directed acyclic graph, each node (or context) may have a parent-child relationship. A node is a parent of another node if this node is one step higher in the hierarchy. For example, node C31 is the parent node of node C41. In another example, node C21 is the parent node of nodes C31 and C32. A node is a child of another node if this node is one step lower in the hierarchy. For example, node C41 is the child node of node C31. In another example, nodes C31 and C32 are child nodes of node C21.

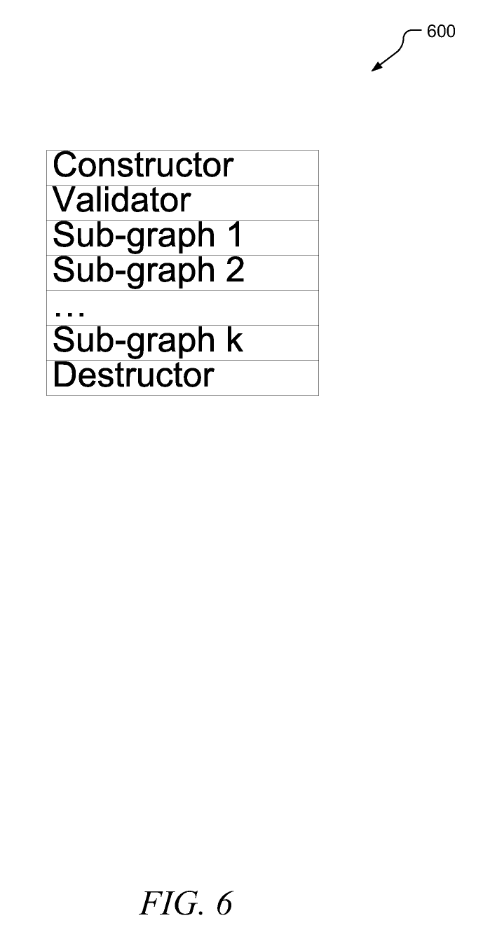

In the system 500 of relationships, each node in the directed acyclic graph may be defined or constructed based on its associated context and the dependencies defined in this context. FIG. 6 defines an example of a template 600 that may be used to define each node, in accordance with an embodiment of the present invention. In this template 500, each node includes a constructor, a destructor, and a validator, as described above, and they may be directly extracted from the context itself. Each node may also define one or more subgraphs, which are defined based on the dependencies. A subgraph of a directed acyclic graph is a graph whose set of vertices and set of edges are all subsets of the directed acyclic graph. For example, returning to FIG. 5, a C12 subgraph includes nodes C12, C23, C24, C34, C35, and C43. In another example, a C26 subgraph includes nodes C26, C37, and C45. It should be noted that in addition to defining the relationships using subgraphs, the system 500 of relationships may use a variety of other techniques to relate the contexts, such as a list of relationships or dependencies, in accordance with an alternate embodiment.

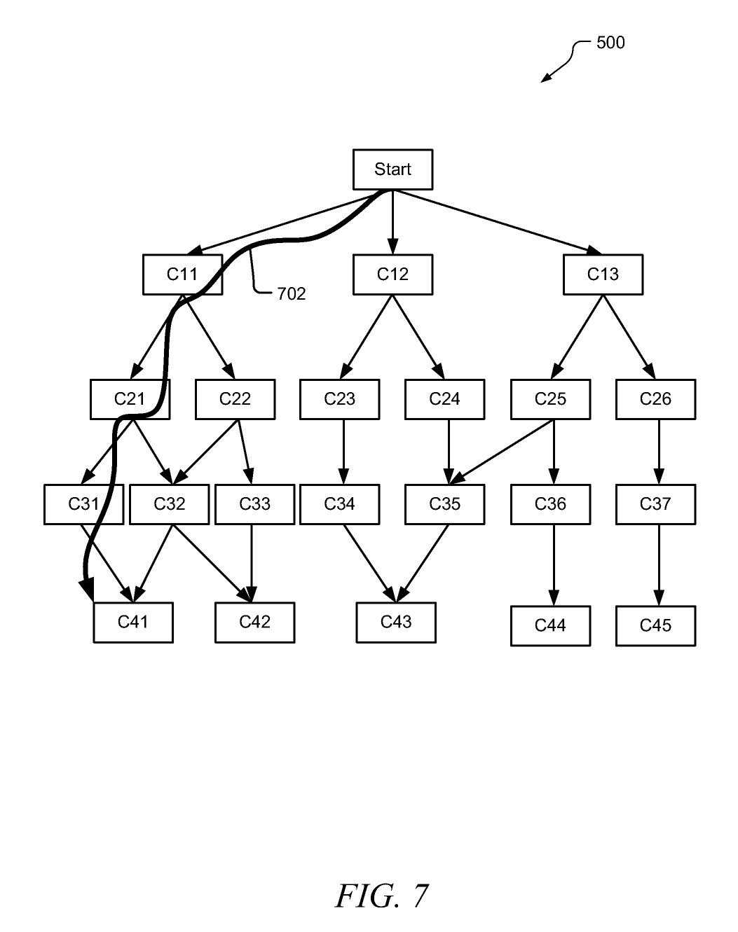

FIG. 7 depicts a graph representation of the system 500 of relationships illustrating executions of tests in a sequence using a number of contexts identified from the system 500. It should be appreciated that a single type of test may be executed based on different combinations of contexts. The execution of the test can follow a variety of different paths along the system 500 of relationships. As an illustration, tests can be executed following a path 702, which traverses nodes C11, C21, C31, and C41.

Here, a context associated with node C11 is accessed and a configuration, for example, defined in this context is accessed. After the application of the configuration, a search is made in the system 500 of relationships to identify whether there are any dependent nodes (or contexts). As discussed above, in one embodiment, the dependent nodes can be identified from the subgraphs defined in each node. As depicted in FIG. 7, node C11 does not define any dependency to a parent node (or parent context) and accordingly, a test is executed using only the context associated with node C11.

Following the path 702 to node C21, another test may be executed. From the system 500 of relationships, node C11 may include information (e.g., subgraph information) that it is a parent node of node C21. As a result, an identification can be made from the system 500 that context associated with node 21 is dependent on the context associated with node C11. The same test can again be executed, but using contexts associated with nodes C11 and C21.

Following the path 702 to node C31, a third test may be executed. From the system 500 of relationships, node C21 may include information that it is a parent node of node C31. As a result, an identification can be made from the system 500 that context associated with node 31 is dependent on the context associated with node C21, which in turn is dependent on context associated with node C11. The same test can again be executed, but using contexts associated with nodes C11, C21, and C31.

Continuing down the path 702 to node C41, a fourth test may be executed. From the system 500 of relationships, node C31 may include information that it is a parent node of node C41. As a result, identification can be made from the system 500 that the context associated with node C41 is dependent on the context associated with node C31, which in turn is dependent on context associated with node C21 and so forth. The same test can again be executed, but using contexts associated with nodes C11, C21, C31, and C41.

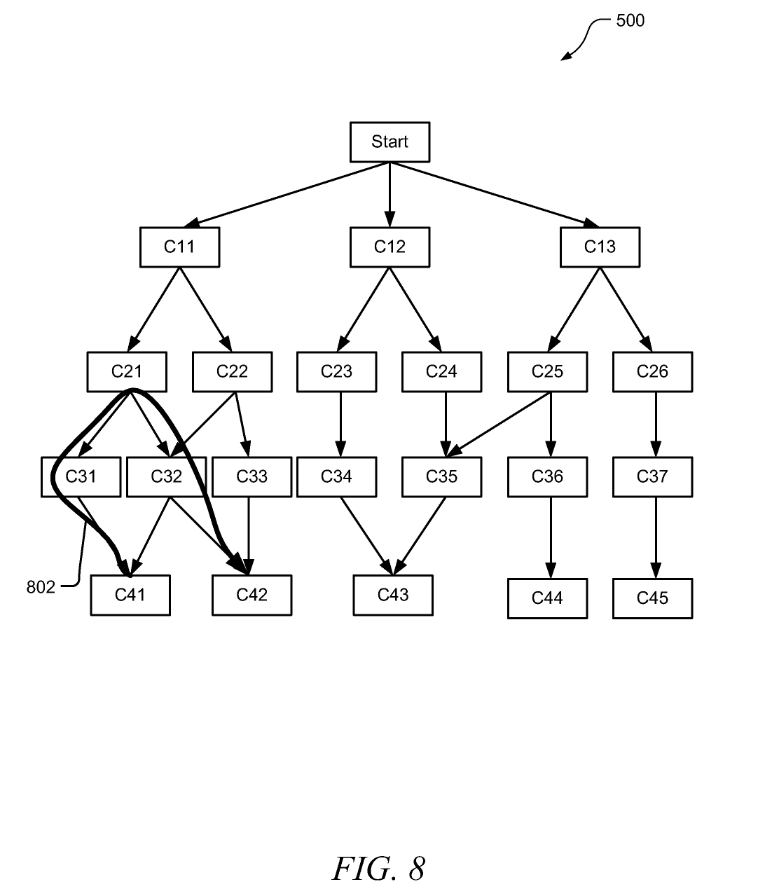

FIG. 8 depicts a graph representation of the system 500 of relationships illustrating executions along a different path 802, in accordance with another embodiment of the present invention. As depicted, this alternate path 802 traverses along nodes C41, C31, C21, C32, and C42. In this example, a series of tests has already been executed following the path 702 illustrated in FIG. 7.

To execute tests along path 802 depicted in FIG. 8, the context associated with node C41 is first undone based on instructions defined in the deconstructor, which can be defined in the node C41 or in its context. From the system 500, the node C31 is identified as a parent node of node C41. A test may then be executed using contexts associated with nodes C11, C21, and C31. However, since this particular test has already been executed previously (see FIG. 7), it does not need to be repeated again.

Following the path 802 to node C21, the context associated with node C31 may also be undone based on a destructor, which can be defined in the node C31 or in its context. After the effects of the context associated with C31 is undone, the node C11 is identified as a parent node of C21. Another test may then be executed that based on contexts associated with nodes C11 and C21. However, since this particular test has already been executed previously (see FIG. 7), it does not need to be repeated again.

Continuing down the path 802 to node C32, another test may be executed. From the system 500 of relationships, nodes C21 and C22 may include information that they are parent nodes of node C32. As a result, identification can be made from the system 500 that the context associated with node 32 is dependent on the contexts associated with nodes C21 and C22, which are dependent on the context associated with node C11. The same test can again be executed, but using contexts associated with nodes C11, C22, and C32.

Following down the path 802 to node C42, a final test may be executed. From the system 500 of relationships, nodes C32 and C33 may include information that they are alternate parent nodes of node C42. As a result, identification can be made from the system 500 that the context associated with node 42 is dependent on the contexts associated with nodes C32 or C33, which in turn are dependent on contexts associated with nodes C21 or C22 and so forth. The same test can again be executed, but using contexts associated with nodes C11, C21, C32, and C42. Furthermore, the same test can again be executed using contexts associated with nodes C11, C22, C32 and C42 and again, using contexts associated with nodes C11, C22, C33 and C42.

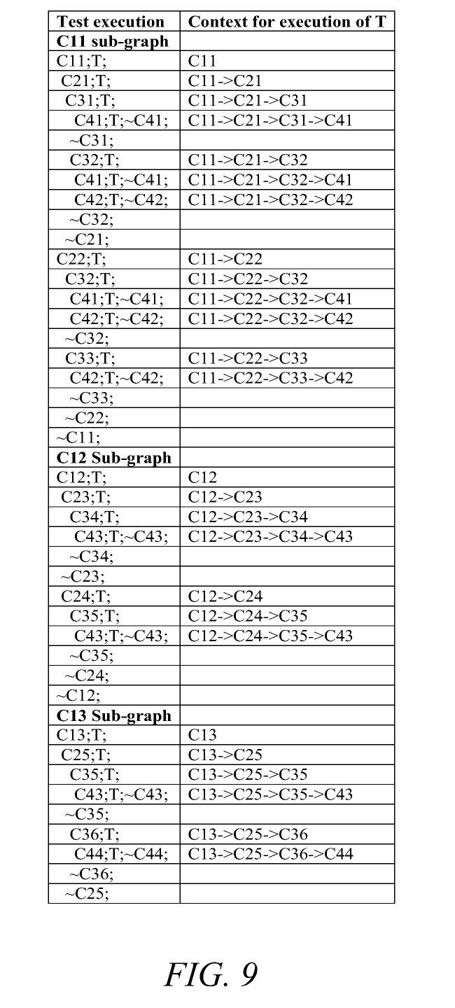

It should be appreciated that the tests may be executed in series based on a variety of different paths traversed within the system 500 of relationships. FIG. 9 is a table that lists some execution sequences for the example of the system 500 of relationships illustrated in FIGS. 5, 7, and 8. In the table of FIG. 9, the term “T” refers to an execution of a test. For example, a test execution sequence of “C11; T” means that a test is executed using the context associated with node C11. The “˜” symbol means the undoing of a particular context. For example, a test execution sequence of “C41; T; ˜C41” means that the test is executed using the context associated with node C41. However, after the test, the effects of the context associated with node C41 is undone.

All the different combinations of tests listed in FIG. 9 show that testing may not be limited to individual contexts. Rather, tests can be executed, for example, using dependent or related contexts. As a result, tests, for example, can be executed to identify interactions between contexts. Furthermore, the separation of tests from their contexts makes the contexts reusable by and portable to other tests.

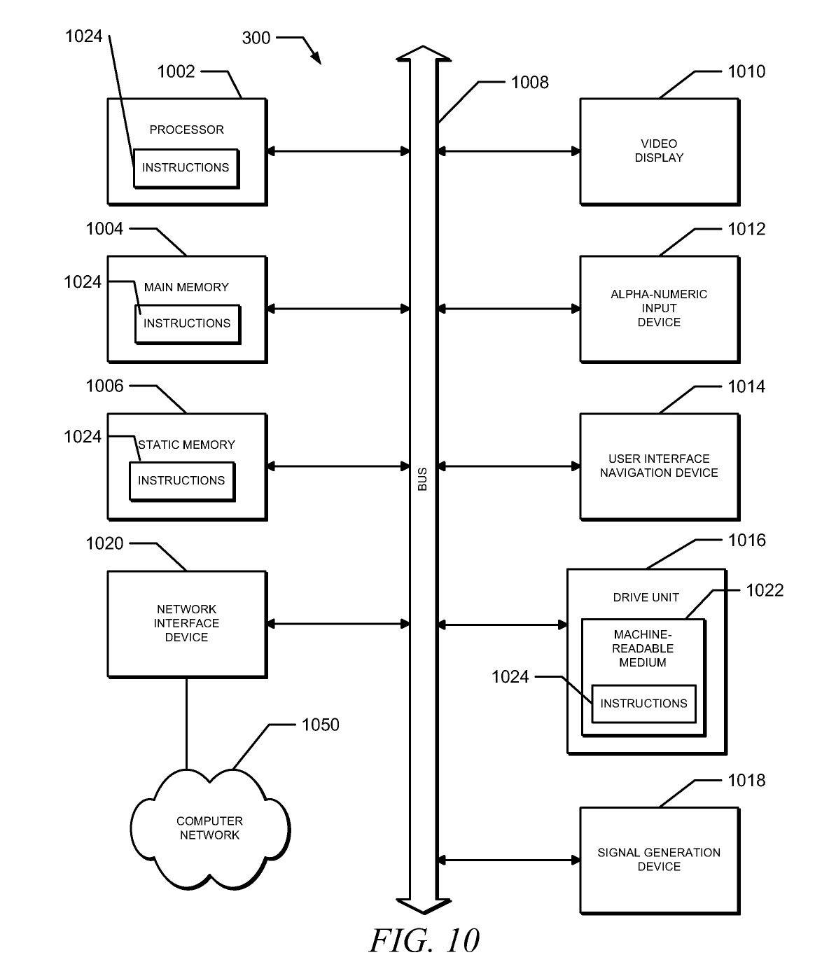

FIG. 10 depicts a block diagram of a machine in the example form of an apparatus 300 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the apparatus 300 includes a processor 1002 (e.g., a central processing unit (CPU), a graphics processing unit (GPU) or both), a main memory 1004 (e.g., random access memory (a type of volatile memory)), and static memory 1006 (e.g., static random access memory (a type of volatile memory)), which communicate with each other via bus 1008. The apparatus 300 may further include video display unit 1010 (e.g., a plasma display, a liquid crystal display (LCD) or a cathode ray tube (CRT)). The apparatus 1000 also includes an alphanumeric input device 1012 (e.g., a keyboard), a user interface (UI) navigation device 1014 (e.g., a mouse), a disk drive unit 1016, a signal generation device 1018 (e.g., a speaker), and a network interface device 1020.

The disk drive unit 1016 (a type of non-volatile memory storage) includes a machine-readable medium 1022 on which is stored one or more sets of data structures and instructions 1024 (e.g., software) embodying or utilized by any one or more of the methodologies or functions described herein. The data structures and instructions 1024 may also reside, completely or at least partially, within the main memory 1004 and/or within the processor 1002 during execution thereof by apparatus 300, with the main memory 1004 and processor 1002 also constituting machine-readable, tangible media.

The data structures and instructions 1024 may further be transmitted or received over a computer network 1050 via network interface device 1020 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the apparatus 300) or one or more hardware modules of a computer system (e.g., a processor 1002 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 1002 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 1002 configured using software, the general-purpose processor 1002 may be configured as respective different hardware modules at different times. Software may accordingly configure a processor 1002, for example, to constitute a particular hardware module at one instance of time and to constitute a different hardware module at a different instance of time.

Modules can provide information to, and receive information from, other hardware modules. For example, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1002 that are temporarily configured (e.g., by software) or permanently configured to perform the relevant operations. Whether temporarily or permanently configured, such processors 1002 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 1002 or processor-implemented modules. The performance of certain of the operations may be distributed among the one or more processors 1002, not only residing within a single machine, but deployed across a number of machines. In some example embodiments, the processor or processors 1002 may be located in a single location (e.g., within a home environment, an office environment or as a server farm), while in other embodiments the processors 1002 may be distributed across a number of locations.

While the embodiment(s) is (are) described with reference to various implementations and exploitations, it will be understood that these embodiments are illustrative and that the scope of the embodiment(s) is not limited to them. In general, techniques for tracking tests may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method comprising:
accessing a plurality of contexts used in a test, the plurality of contexts being defined separate from the test, and a first context in the plurality of contexts defining a dependency to a second context in the plurality of contexts;
constructing a system of a plurality of relationships between the plurality of contexts based on the dependency defined by the first context; and
executing the test using a number of the plurality of contexts identified from the system of the plurality of relationships.

2. The method of claim 1, wherein the construction of the system of the plurality of relationships comprises:
identifying the dependency from the first context; and
relating the first context to the second context.

3. The method of claim 1, wherein the system of the plurality of relationships is constructed as a directed acyclic graph comprising a plurality of nodes, each node in the plurality of nodes being associated with a single context in the plurality of contexts.

4. The method of claim 1, wherein the dependency defines the second context being a parent of the first context, and wherein the execution of the test comprises:
accessing the second context;
executing the test using the second context;
identifying the first context from the system of the plurality of relationships;
accessing the first context; and
executing the test using the first context and the second context.

5. The method of claim 1, wherein the plurality of contexts includes a third context that defines a further dependency to the second context, wherein the dependency defines the second context being a parent of the first context, wherein the further context defines the second context being the parent of the third context, and wherein the execution of the test comprises:
executing the test using the first context and the second context;
undoing the second context;
identifying the third context from the system of the plurality of relationships;
accessing the third context; and
executing the test using the first context and the third context.

6. The method of claim 1, wherein the test is a set of a plurality of instructions and the plurality of contexts is excluded from the set of the plurality of instructions.

7. The method of claim 1, wherein the plurality of contexts defines a plurality of configurations used for the test.

8. The method of claim 1, wherein the first context defines a configuration used for the test and the first context further includes an instruction to undo the configuration.

9. The method of claim 1, wherein the first context defines a configuration used for the test and the first context further includes an instruction to validate an outcome of the configuration.

10. A machine-readable medium that stores instructions, which, when performed by a machine, cause the machine to perform operations comprising:
accessing a plurality of contexts used in a test, the plurality of contexts being defined separate from the test, and a first context in the plurality of contexts defining a dependency to a second context in the plurality of contexts;
constructing a system of a plurality of relationships between the plurality of contexts based on the dependency defined by the first context; and
executing the test using a number of the plurality of contexts identified from the system of the plurality of relationships.

11. The machine-readable medium of claim 10, wherein the operation of constructing the system of the plurality of relationships comprises:
identifying the dependency from the first context; and
relating the first context to the second context.

12. The machine-readable medium of claim 10, wherein the system of the plurality of relationships is constructed as a directed acyclic graph comprising a plurality of nodes, each node in the plurality of nodes being associated with a single context in the plurality of contexts.

13. The machine-readable medium of claim 10, wherein the dependency defines the second context being a parent of the first context, and wherein the operation of executing the test comprises:
accessing the second context;
executing the test using the second context;
identifying the first context from the system of the plurality of relationships;
accessing the first context; and
executing the test using the first context and the second context.

14. The machine-readable medium of claim 10, wherein the plurality of contexts includes a third context that defines a further dependency to the second context, wherein the dependency defines the second context being a parent of the first context, wherein the further context defines the second context being the parent of the third context, and wherein the operation of executing the test comprises:
executing the test using the first context and the second context;
undoing the second context;
identifying the third context from the system of the plurality of relationships;
accessing the third context; and
executing the test using the first context and the third context.

15. The machine-readable medium of claim 10, wherein the plurality of contexts defines a plurality of parameters used for the test.

16. An apparatus comprising:
a content library configured to store a plurality of contexts; and
a test execution module configured to:
access the plurality of contexts used in a test from the context library, the plurality of contexts being defined separate from the test, and a first context in the plurality of contexts defining a dependency to a second context in the plurality of contexts;
construct a system of a plurality of relationships between the plurality of contexts based on the dependency defined by the first context; and
execute the test using a number of the plurality of contexts identified from the system of the plurality of relationships.

17. The apparatus of claim 16, wherein the construction is further configured to:
identify the dependency from the first context; and
relate the first context to the second context.

18. The apparatus of claim 16, wherein the dependency defines the second context being a parent of the first context, and wherein the execution of the test is further configured to:
access the second context;
execute the test using the second context;
identify the first context from the system of the plurality of relationships;
access the first context; and
execute the test using the first context and the second context.

19. The apparatus of claim 16, wherein the plurality of contexts includes a third context that defines a further dependency to the second context, wherein the dependency defines the second context being a parent of the first context, wherein the further context defines the second context being the parent of the third context, and wherein the execution of the test is further configured to:
execute the test using the first context and the second context;
undo the second context;
identify the third context from the system of the plurality of relationships;
access the third context; and
execute the test using the first context and the third context.

20. An apparatus comprising:
a library module configured to store a plurality of contexts used in a test, the plurality of contexts being defined separate from the test, and a first context in the plurality of contexts defining a dependency to a second context in the plurality of contexts;
a test execution module configured to access the plurality of contexts used in the test from the library module;
a first means for constructing a system of a plurality of relationships between the plurality of contexts based on the dependency defined by the first context; and
a second means for executing the test using a number of the plurality of contexts in a sequence based on the system of the plurality of relationships.
